(19) United States
(12) Patent Application Publication
(10) Pub. No.: US 2008/0103907 A1
(43) Pub. Date: May 1, 2008

(54) APPARATUS AND COMPUTER CODE FOR PROVIDING SOCIAL-NETWORK DEPENDENT INFORMATION RETRIEVAL SERVICES

(75) Inventors: Ariel Maislos, Sunnyvale, CA (US); Ruben Maislos, Or-Yehuda (IL); Eran Arbel, Cupertino, CA (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Pudding Ltd., Kefar-Saba (IL)

(21) Appl. No.: 11/923,762

(22) Filed: Oct. 25, 2007

Related U.S. Application Data
(60) Provisional application No. 60/862,769, filed on Oct. 25, 2006.

(51) Int. Cl. G06F 17/30; G06Q 30/00; G10L 15/00

(52) U.S. Cl. 705/14; 704/231; 707/3; 707/E17.014

(57) ABSTRACT

Methods, apparatus and computer code for providing information retrieval services (e.g. handling search queries and providing electronic advertising) in accordance with a given user's social network are disclosed herein. In some embodiments, an information retrieval operation is handled according to the click stream and/or taste profile and/or user profile of different associated users of the social network—for example, indirect contacts. The respective influence, for any associated user (i.e. within the social network), of the associated user's click stream and/or taste profile and/or user profile on the handling of an information retrieval operation for the “given user” may be determined by a “closeness function” between the associated user and the given user. The closeness function and/or the taste profile and/or user profile of any associated user may, in some embodiments, be determined by analyzing electronic communications—for example, text chat communications and/or voice communications that optionally include video.

### CROSS-REFERENCE TO RELATED APPLICATIONS

### This patent application claims the benefit of U.S. Provisional Patent Application No. 60/862,769 filed Oct. 25, 2006 by the present inventors.

### FIELD OF THE INVENTION

The present invention relates to techniques for information retrieval and presentation.

### BACKGROUND AND RELATED ART

One of the challenges of information retrieval services is the need to provide users with the most relevant search results and advertising. For example, in the search engine domain, search results for a given query are ranked by factoring-in the general popularity of a URL as reflected by other sites (e.g., Google) or by man-made directory (e.g., del.icio.us).

The following published patent applications provide potentially relevant background material: US 2005/0015432; US 2006/0218111; US 2006/0167747; US 2003/0195801; US 2006/0188855; US 2002/0062481; US 2005/0234779. All references cited herein are incorporated by reference in their entirety. Citation of a reference does not constitute an admission that the reference is prior art.

### SUMMARY

According to one aspect, the present inventors are now disclosing an apparatus and technique for improving the relevance of results produced by information retrieval systems by leveraging the user's social network. For each “associated user” in the social network, a description of an interests and/or intent and/or behavior of the associated user. For example, this may be carried out by (i) accessing a publically available self-description of the associated user for example, a mySpace® or FaceBook® profile; and/or (ii) monitoring a clickstream of “associated users” and/or (iii) by analyzing (as permitted by law—for example, with permission of the associated user) electronic communications (e.g. telephone or VOIP conversations, text chat, video conversation) of the associated user to determined a personality or preferences or tastes of the associated users.

This information about the behavior/taste/interests/intentions/demographics of various “associated users” in a social network can be leveraged for a number of purposes. In one example, search results may be ordered by and/or augmented with the aforementioned behavior/taste/intentions/demographic data of “associated users.”

Thus, in one example, if an associated user (i.e. “friend” or “friend of friend”) is interested in biking, and a search query relates to vacationing in a certain city, the search results may be ordered in favor of “biking-friendly” destinations.

In some embodiments, this “associated user” intent/taste/demography/behavior data may be used to provide an indication of “buzz” of what is popular among a given user's “direct friends” or “indirect contacts” (2^{nd} degree—i.e. friends of friends or greater). This information may be leveraged to provide a “given” user with more relevant search results and/or advertisements.

Thus, certain aspects of the present invention are predicated on the following assumptions: (i) people who are related to the user are likely to have similar intents, interests and information retrieval patterns. (ii) people are likely to accept recommendations from people they know and trust over the general population.

In one example, handling a search query in accordance with a user's social network includes giving higher ranking to search results and advertisements that are popular with the user's social network.

Another example relates to augmenting context-related results—for example, indicating that “Members in your social network who viewed this item also viewed . . . ”: When information about a specific context is retrieved, the system also shows related topics that were popular with contacts in the user's social network.

As will be described below, there are various techniques for determining a given user's social network, closeness of relations within the social network, and an associated user's behavior/taste/intentions/demographics.

It is now disclosed for the first time a method of providing information retrieval services, the method comprising: a) for a plurality of users, analyzing content of multi-party electronic communications between individual users of said plurality of users, said analyzed electronic communications including at least one of text chat communications and voice-content-including media communications; b) for a given user of said plurality of users, determining, a social network comprising a plurality of distinct indirect contacts; c) for each indirect contact of said plurality of indirect contacts of said social network, determining a respective indirect contact social network closeness function between said given user and said each indirect contact from at least one of: i) at least one word feature of said analyzed content of said electronic communications; ii) at least one audio feature of said analyzed content of said electronic communications, and iii) at least one video feature of said analyzed content of said electronic communications; d) effecting at least one information retrieval operation selected from the group consisting of: i) handling a search query; and ii) providing advertising, in accordance with said determined indirect contact social network closeness functions.

According to some embodiments, said indirect contact social network closeness functions are determined in accordance with said word features of said analyzed content.

According to some embodiments, said indirect contact social network closeness functions are determined in accordance with said audio features of said analyzed content.

According to some embodiments, said indirect contact social network closeness functions are determined in accordance with said video features of said analyzed content.

According to some embodiments, said indirect contact social network closeness functions are determined in accordance an audio speech delivery feature of said analyzed content selected from the group consisting of: a) a voice pitch feature; b) a voice inflection feature; c) a voice loudness feature; and d) a speech tempo feature.

According to some embodiments, said indirect contact social network closeness functions are determined in accordance with at least one of: i) at least one emotion feature of said analyzed content; ii) at least one mood feature of said analyzed content.

Alternatively, this may be from explicit recommendations.

According to some embodiments, the method further includes: e) determining for said each indirect contact of said plurality of indirect contacts, a respective at least one user person-describing function selected from the function group consisting of: i) a respective taste function; ii) a respective personality function; iii) a respective demographic function; wherein said handling of said at least one information retrieval operation is carried out in accordance with said person-describing functions weighted according to said closeness functions.

According to some embodiments, said at least one said respective person-describing function for said each indirect contact is determined at least in part by a clickstream of a respective device of said each indirect contact.

According to some embodiments, said respective at least one respective person-describing function for said each indirect contact is determined at least in part by at least one of: i) said at least one word feature of said analyzed content of said electronic communications; ii) said at least one audio feature of said analyzed content of said electronic communications, and iii) said at least one video feature of said analyzed content of said electronic communications.

According to some embodiments, said respective demographic function for said each indirect contact is determined at least in part by at least one of:

According to some embodiments, said at least one feature includes at least one demographic feature selected from the group consisting of: i) a gender feature; ii) an educational level feature; iii) a household income feature; iv) a weight feature; v) an age feature; and vi) an ethnicity feature.

According to some embodiments, said at least one said demographic feature is determined in accordance with at least one: i) an idiom feature of said analyzed content of said electronic communications; ii) an accent feature of said analyzed content of said electronic communications; iii) a grammar compliance feature of said analyzed content of said electronic communications; iv) a voice characteristic feature of said analyzed content of said electronic communications; v) a sentence length feature of said analyzed content of said electronic communications; and vi) a vocabulary richness feature of said analyzed content of said electronic communications.

According to some embodiments, said determined closeness function is a query-topic independent closeness function.

According to some embodiments, said determined closeness function is a query-topic dependent closeness function.

According to some embodiments, said handling of said search query includes providing, in accordance with said determined indirect contact social network closeness functions, an order for search results.

According to some embodiments, said handling of said search query includes associating, with a list of search results, in accordance with said determined indirect contact social network closeness functions, a description of at least one preference of at least one said indirect contact.

It is now disclosed a method of providing information retrieval services, the method comprising: a) for a plurality of users, analyzing content of multi-party electronic communications between individual users of said plurality of users, said analyzed electronic communications including at least one of text chat communications and voice-content-including media communications; b) for a given user of said plurality of users, determining, a social network comprising a plurality of distinct indirect contacts; c) for each indirect contact of said plurality of indirect contacts of said social network, determining a respective at least one user person-describing function selected from the function group consisting of: i) a respective taste function; ii) a respective personality function; iii) a respective demographic function, in accordance with at least one of: i) at least one word feature of said analyzed content of said electronic communications; ii) at least one audio feature of said analyzed content of said electronic communications, and iii) at least one video feature of said analyzed content of said electronic communications, d) effecting at least one information retrieval operation selected from the group consisting of: i) handling a search query; and ii) providing advertising, in accordance with at least one said user person-describing function.

It is now disclosed a method of providing information retrieval services, the method comprising: a) determining, for a given user, a social network including a plurality of associated users; b) analyzing electronic media content of multi-party electronic communications between at least two said associated users, said analyzed electronic communications including at least one of text chat communications and voice-content-including media communications; c) in accordance with at least one of: i) at least one word feature of said analyzed content of said electronic communications; ii) at least one audio feature of said analyzed content of said electronic communications, and iii) at least one video feature of said analyzed content of said electronic communications, effecting at least one information retrieval operation selected from the group consisting of: i) handling a search query for said given user; and ii) providing advertising for said given user.

According to some embodiments, at least two associated users include at least two indirect contacts of said social network.

It is now disclosed a method of providing information retrieval services, the method comprising: a) determining, for a given user, a social network including a plurality of associated indirect contacts; b) for each said associated indirect contact of a plurality of said plurality of contacts, determining a respective user interest commonality function of: (i) said given user; (ii) said each associated contact; and c) in accordance with said determined interest commonality functions, effecting at least one information retrieval operation for said given user selected from the group consisting of; i) handling a search query; and ii) providing advertising.

According to some embodiments, i) said determining of said social network includes determining respective closeness functions of said each associated indirect contact; ii) said interest commonality function-dependent effecting of said at least one information retrieval operation is carried out in accordance with said determined closeness functions.

These and further embodiments will be apparent from the detailed description and examples that follow.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

FIG. 1A-1B provide a flow charts of an exemplary technique for handling search queries and/or providing advertisement in accordance with a target user's social network.

FIG. 2A-2C depict exemplary social networks and descriptive weight and distance functions.

FIG. 3 depicts a routine for determining a user weight function in accordance with an information retrieval topic.

FIG. 4 provides a block diagram of an exemplary system for handling information retrieval operations in accordance with a target user's social network.

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for social network-based handling of search queries or provisioning of advertising is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

### Introduction and a Discussion of Some Use Cases

According to one aspect, the present inventors are now disclosing an apparatus and technique for improving the relevance of results produced by information retrieval systems by leveraging the user's social network. For each “associated user” in the social network, the intent and behavior of the associated user is tracked. For example, this may be carried out by accessing the associate's user social network profile (e.g. a “mySpace® profile”) and/or by analyzing electronic communications (e.g. telephone or VOIP conversations, text chat, video conversation—accessed as permitted by law—for example, with appropriate consents) of the associated user.

The presently-disclosed techniques are applicable to any information retrieval system, including but not limited to search engines and advertisement servers.

### Use Case 1

### Ordering and/or Filtering Search Results

In one use-case, a given user (i.e. “John”) is searching the Internet for information about trips in the Bay Area. According to this example, a known search engine algorithm (for example, Google's PageRank™) may place the most popular URLs at the top of the list. Using one or more presently disclosed teachings, the URLs may be ordered or ranked in accordance with one or more behavior or taste profiles of the given user's friends. In one non-limiting example, the behavior or taste profile of any “friend” or associated user may be determined according to the associate user's clickstream.

Thus, in the present non-limiting use case, if a number of John's friends have clicked on the ‘Monterey Bay Aquarium’ link while searching for trips in the Bay Area, then this result may be displayed as one of the top results. The system provides additional recommendations: “Friends in your network who searched for Bay Area trips where also interested in The Big Sur and Sausalito”.

In a first variation of the aforementioned use case, instead of (or in addition to) using the associate user's clickstream, other information about the associated user or “friend” may be used. For example, telephone or VOIP calls or text chat messages of the associated user or “friend” may be analyzed (i.e. where permitted by law—for example, with permission from the associated user)—if the associated user or friend speaks highly of a given tourist destination in the Bay Area, the search links that John receives may be ordered to give a higher ranking to the given tourist destination.

### Use Case 2

### Advertisement

The same principle applies to advertisements as well: advertisements for activities and restaurants in the Bay Area which received more attention from John's friends may be displayed at the top of the ads list.

In another example, the cost of serving advertisements to John may be determined in accordance with previous attention received from John's friends.

### Use Case 3

### User Closeness

In another variation, John may have some associated users or “friends” who are “closer” to John (for example, who speak with John on a regular basis), and other associated users that are more “distant” from John.

According to this example, the different associated users of the social network may “compete” to influence the search results present to John where the “closer” associated users “wield more influence” on the search results (or advertisement searching) than the “more distant” users.

Thus, the “closer” contacts or associated users shall receive more weight than “more distant”

Several techniques for determining “relationship closeness/distance” are now discussed.

In one example, phone or VOIP records of “John” and/or any other user in the social network are analyzed. If John regularly speaks to a first friend several times a week, and only to a sporadically to a second friend, than “recommendations” from the clickstream of the first friend may be given priority over recommendations from the second friend.

Another metric of closeness” is “degree of separation.” Thus, in another example, clickstreams from 1^{st} degree contacts may influence search results or served advertisements more than clickstreams from 2^{nd} degree contacts, which may have greater influence than 3^{rd} degree contacts.

Another metric relates to “type of relationship.” Thus, in some use cases, people who have a romantic or familial connection may be “closer” to each other than business associates even if they speak less frequently.

In one example, it is possible to analyze electronic communications between different users of the social network to determine the “nature” of the “relationship” between the users of the social network—i.e. the closeness, the “type” of relation (i.e. romantic vs. friendship vs. business vs. familial vs. acquaintance), etc. This may be done by monitoring key words or phrases (for example, if the word “honey” is used often in a conversation, this term of endearment may indicate a romantic or familial relation).

In another example, emotions and/or moods during voice conversations (i.e. audio and optionally video) are monitored as a possible indicator of “closeness.”

Emotions and/or moods may be determined, for example, according to key words, voice tone, or visually for the specific case of “video conversations.”

### Use Case 4

### Contact Type

In another example, the “weight” given to a particular associated user's clickstream (or other indicator of preferences or taste) may depend on the circumstances of the “information retrieval operation.” Thus, in one example, associated users are categorized as “friends” or “co-workers.”

This categorization may be effected in a number of ways. For example, some social networks such as “LinkedIn” allow one to determine of two individuals are co-workers or not. Alternatively, electronic communications (for example, voice communications including audio and optionally video or text communications such as “chat” instant messages or emails) may be monitored to determine the “type of relationship.”

In one example, if the search query relates to a recreational activity, then the clickstreams or “preferences” or “tastes” of family members may be given a greater weight than the clickstreams or “preferences” or “tastes” of co-workers. This may be reversed if, on the other hand, the search query relates to “business management technique.”

### Use Case 5

### Level of Trust

Users can give a ‘thumbs-up’ (“I trust this person's opinion”) or a ‘thumbs-down’ indication to other visible users in their network. The algorithm may promote results from people who are trusted by their peers. Conversely, the technique may demote the ranking of the clickstream of people who are not as trusted by their peers.

### Use Case 6

### Expertise Level

Users who frequently access topics that are related to a given domain may be considered to be ‘domain experts’, and for a given context their clickstream may receive more weight than users whose clickstream pattern does not indicate frequent access to topics related to the context.

Users may attach tags and comments to URLs, thus further enriching the metadata of the URL.

### A Discussion of the Figures

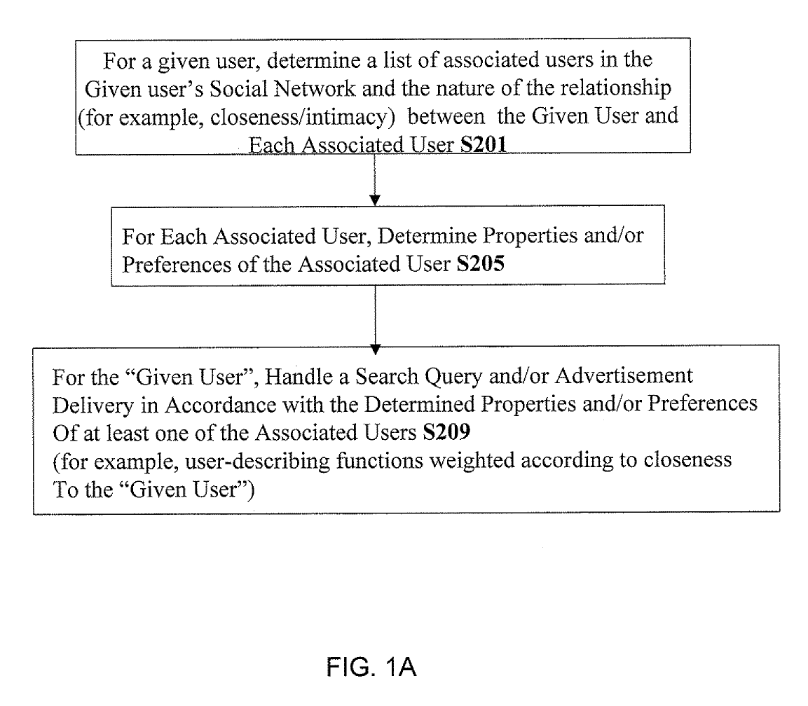

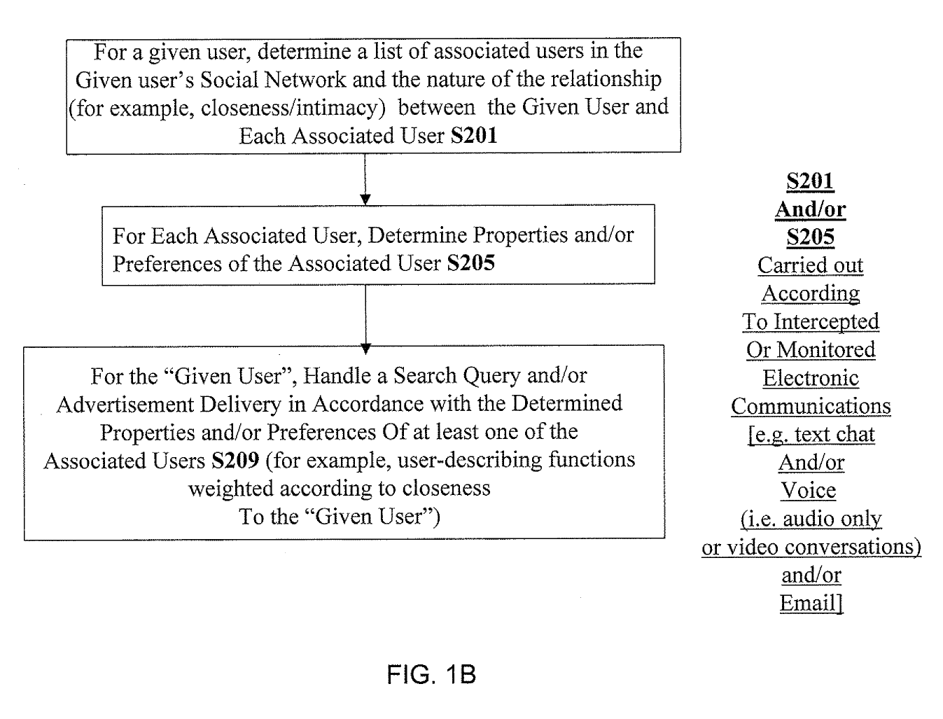

FIG. 1 provides a flow chart of an exemplary technique for information retrieval in accordance with some embodiments of the present invention. According to the example of FIG. 1 (i) a determination S201 is made, for a given user, of the given user's “associated users” (i.e. users separated a single ‘degree of separation’ and/or by multiple degrees of separation) and optionally information about the ‘nature’ of the relationship (i.e. direct or indirect) with one or more associated users is made; (ii) in step S205, one or more properties or preferences of the associated users (for example, tastes of the associated user(s), behaviors or habits of the associated user(s), demographic properties of the associated user(s), etc); (iii) in step S209, a search query response and/or advertisement provisioning is handled according in information determined in one or more previous steps.

### Determination of a Directory of a User's Social Network 201

In step S201, information is provided associating a given user with a “social network,” This may be done in a number of ways. In one example, one or more of (i) a user's voice conversations and/or (ii) a user's email communications and/or (iii) a user's instant message (IM) or “chat” communications and/or (iv) a user's text message communications (for example, SMS communications) analyzed.

In an alternative example, this information may be acquired from an online social network (for example, Facebook® or mySpace® or LinkedIn® or any other online social network)—for example, by purchasing this information or sending a webcrawler to monitor content of the online social network.

In an alternative example, this data may be obtained from any other online directory—for example, an online white pages which identifies people in geographic proximity of each other.

It is appreciated that in some embodiments, the given user's social network is monitored on an ongoing basis, and relevant databases are updated in response to activities of the ‘given user’ and/or one or more associated users.

As indicated in the comment on the right hand side of FIG. 1B, in some embodiments, each of steps S201 and/or S205 may be carried out in accordance with intercepted or monitored (i.e. as permitted by law—for example, with permission of electronic communications between different users of the social network.

### Determination of the Nature of a Given User's Relationship with “Associated Users” of the Social Network S201

### A First Discussion

One example of the “nature” of the given user's relation with “associated users” is the “closeness” between the ‘given user’ and one or more associated users. This may be determined by (i) “degrees of separation” and/or (ii) the “user pair closeness” of any given ‘relationship’ between two individuals (i.e. between the given user and an associated user and/or between two associated users).

This ‘user pair closeness’ (i.e. for any pair of users) may be determined in a number of ways including but not limited to (i) means of communications (i.e. emails vs. text messaging vs. (ii) the frequency of communications (for example, the frequency of instant text messages or voice communications or video conversations or emails) between the pair of users; (iii) duration of communications (for example, durations of individual voice conversations, total elapsed time of all voice conversations during a given time period).

In another example, users who talk during “business hours” are more likely to be business associates or co-workers than users who talk during “evening/night/off hours/weekends.”

### Determination of the Nature of a Given User's Relationship with “Associated Users” of the Social Network S201 (for Example, “Closeness”)

### A Second Discussion Related to Analyzing Actual Content of Inter-User Communications to Determine Closeness

In some embodiments, the communication(s) between the “given user” and members of the social network (or alternatively, between communication(s) between two or more member(s) of the social network—even communications that do not include the “given” user) are analyzed, and one or more parameters describing the nature of the relationship between two communicating users may be determined.

Exemplary parameters describing, at least in part, a “nature of a relationship” include but are not limited to:
a) a frequency of key words or phrases this could be indicative of a relationship between two individuals in a multi-party conversation—for example, if the word “honey” is common in a voice conversation, this may be indicative of an intimate relation between the two parties; alternatively, if emails are signed “Love, . . . ” this may also indicative of an intimate relation;
b) conversation topics—this may be indicative of common interests or of the nature of the relationship between two individuals—for example, two individuals who speak frequently of the stock market are more likely to be business associates; individuals who speak about the “meaning of love” are more likely to be close friends or lovers.
c) body language (for example, for video conversations) certain emotions such as joy or anger may be detectable from user's body language.
d) moods or emotions—in one example, if a person tends to exhibit a “happy” emotion at the beginning of the conversation (or at other times of the conversation), this may indicative of a more intimate relation.
e) mood or emotion deviation—it is possible that the type of relation of two individuals varies over time; this may be monitored to determine the nature of the relationship between two individuals. In one example, when two users are getting “closer to each” this may cause a greater weight to be awarded to one or more of these users in a social network;
f) “dominant-subordinate” parameters—in one example, a first user has a more “dominant” personality while a second user has a more “subordinate personality.” This may be determined, for example, from key words, voice tones, emotions, etc.
g) speech delivery parameters—e.g. tempo, volume, etc. Certain speech delivery patterns may be indicative of various emotional states, preferences, affinities, or relationship closeness.

In some embodiments, a parameter describing an estimate level of “closeness” that the “given” user with any user(s) in the social network may be computed.

In one example, if the given user uses certain “positive” key words or phrases during one or more voice conversations (or IM sessions or text conversations or email exchanges) (for example, “you are smart,” “I trust you,” “you're the man,”; etc.), this may indicate an elevated level of closeness. Conversely, a reduced level of trust may be indicated by “negative” key words (for example, “you are stupid,” etc).—in this case, even if the two users converse frequently, if they have a “bad relationship,” this may indicate that they are, in fact, not “close.” in another example, it is determined how often, during one or more voice conversations (or IM sessions or text conversations or email exchanges), two speaking parties agree or disagree with each other.

In an example relating to voice conversation, tone of voice may be detected and used to determine a degree of trust—for example, how to “handle” key phrases. Thus, it may be determined if the phrase “you are so smart” is said sincerely or sarcastically.

In an example relating to video conversations, body language may be used to determine a level of trust.

It is noted that the relationship “closeness” parameters may be computed for a single conversation, or over a plurality of conversations.

It is appreciated that the concept of determining “closeness” from analyzed communication between users may be extended to determining trust between “indirectly communicating users.” Thus, in one example, user A communicates with user B (e.g. by email or texting or voice conversation), and user B communicates with user C. In this example, the closeness between users “A” and “C” (where user “C” is an “indirect contact”) may be a function of (i) the closeness determined from analyzed communication(s) between users “A” and “B”; (ii) the closeness determined from analyzed communication(s) between users “B” and “C.”

### Determining “Closeness” in a Social Network

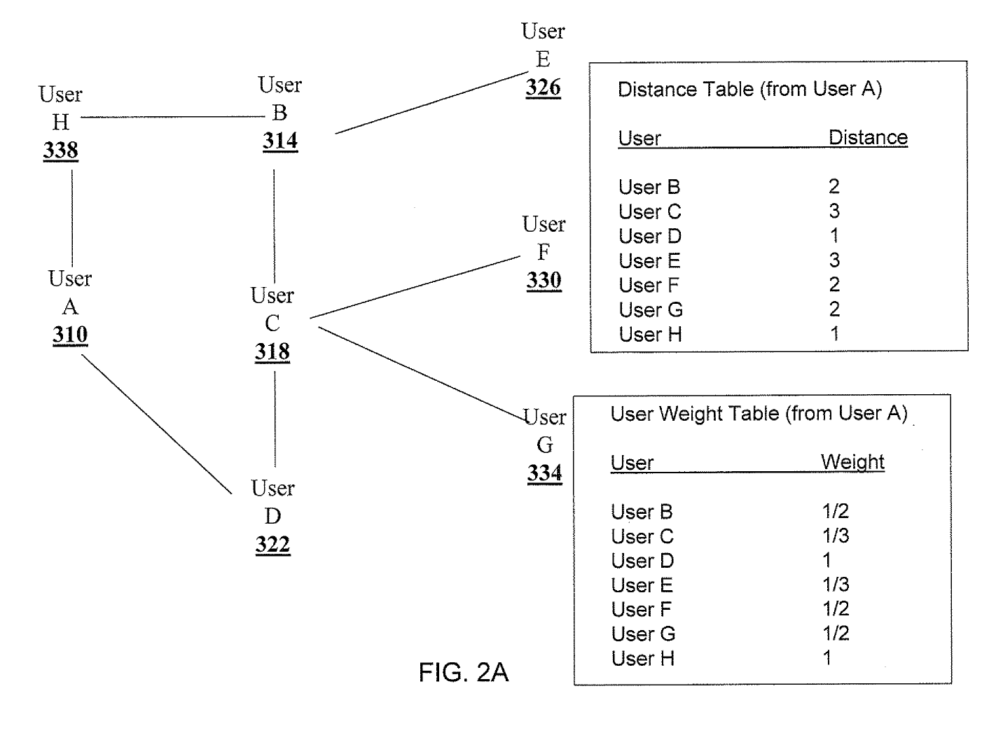

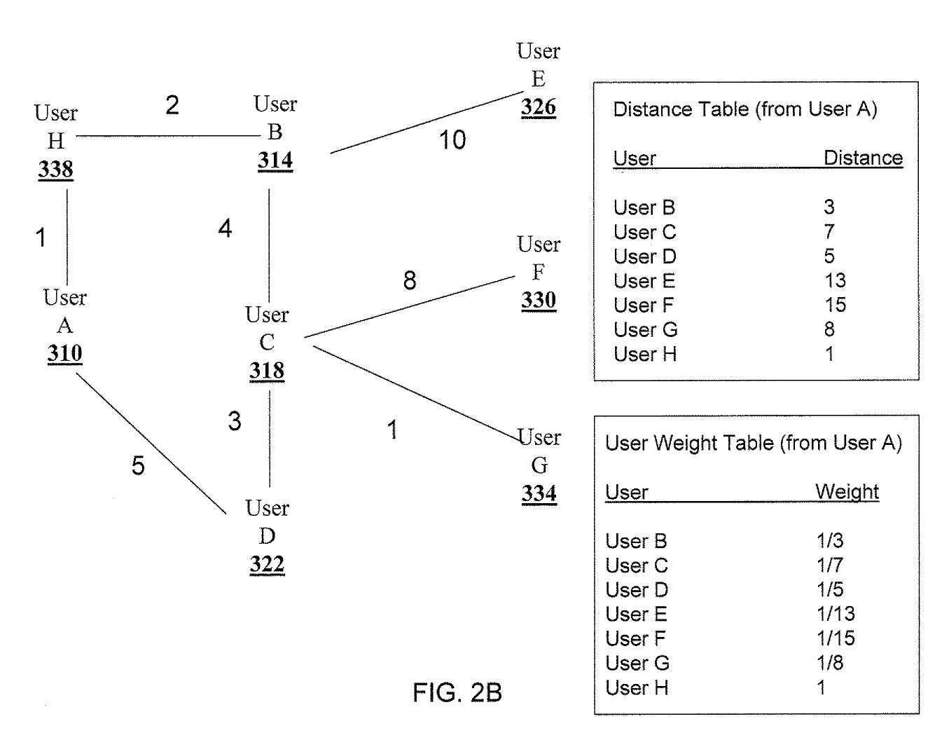

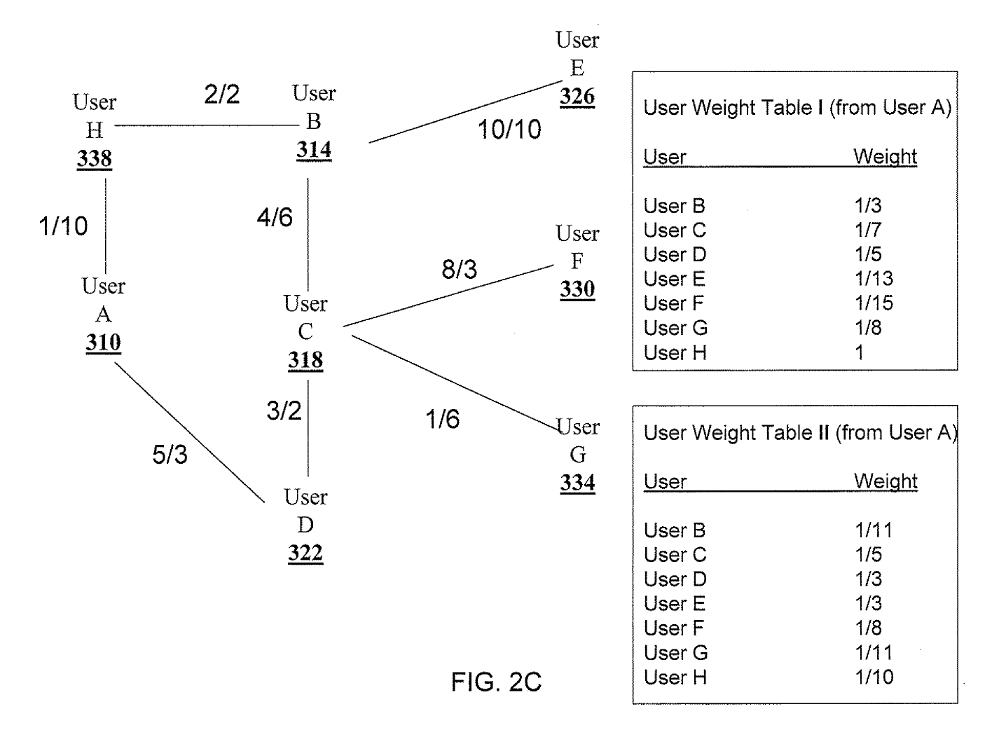

### A Discussion of FIGS. 2A-2B

FIGS. 2A-2C describe several techniques for determining how much “influence” or “weight” one or more “associated users” may have on information retrieval services provided to the “given user.” In one example, this may determine how much “weight” clickstreams or other indicators of preferences/tastes/behavior are given to influence how a given information retrieve operation is carried out.

In the example of FIG. 2A, the distance between users is always “1”—i.e. distance is determined as the “degree of contact.” Accordingly, users that are further away will have their behavior/preferences/taste weighted less than users who are “closer.”

In contrast to the example of FIG. 2A, in the example of FIG. 2B, the “closeness” between different users who are “direct contact” is not assigned the value of “1.” Instead, the “closeness” may be determined in accordance with one or more factors for examples, from analyzing electronic communications as described above. Thus, users A 310 and H 338 may be extremely close friends or lovers, while users B 314 and C 318 may be business associates. Users B 314 and E 326 may be “distant” acquaintance.

When determining how to provide information retrieval services for user A 310 (for example, how to serve advertisements or order or augment search results), the weight table of FIG. 2B may be used, where greater weight is given to “closer” users.

### Closeness or Associated User Relative Weight Function on the Information Retrieval Topic and/or Purpose

In one example, the “given” user is a teenage girl. Some members of her social circle are fellow teenage girls, while other members of her social circle are, for example, family members of other demographic groups.

According to this example, if the topic of the information retrieval operation relates to a subject where the “teenage girl” demographic has extra importance (for example, popular music), the social network contacts (i.e. direct and/or indirect contacts) in this demographic are given extra importance. Thus, the “clickstreams” (or tastes/behaviors/habits) of the users who are fellow teenage girls may be given extra weight.

If, on the other hand, the topic of the information retrieval operation relates to a subject where the “religion” demographic has extra importance (for example, a search for local religious services), the social network contacts (i.e. direct and/or indirect contacts) in this demographic are given extra importance. Thus, if the given user is Catholic, the “clickstreams” (or tastes/behaviors/habits) of the users who are Catholic may be given extra weight.

The demographic parameters may be determined, for example, in accordance with a mySpace® profile, or by analyzing electronic communications of the given user or any associated user(s) of the social network.

Thus, as shown in FIG. 2C, the weight function (or even the distance function) may vary. Table I provides one set of weights and table II provides a different set of weights.

In one example, each weight table is tagged with information describing what types of information retrieval queries best match the weight table. Thus, one weight table may be tagged as “for use with information retrieval queries that most closely match the age and/or sex demographic” while another weight table may be tagged as “for use with information retrieval queries that most closely match the religion demographic.”

Thus, in the example of FIG. 2C the “distance” or “weight function” used for an associated user may dependent on the topic or subject of the “information retrieval operation.” Thus, if the “information retrieval operation” relates to “pop music,” contacts of a teenage girl who are the same age and/or sex may be given greater weigh. If, on the other hand, the “information retrieval operation” relates to “gardening tips,” we may not give additional weight to the “teenage girl” contacts in the social network (i.e. direct and indirect social network).

Thus, for the case of “popular music” the query topic will cause certain contacts to be “closer” to the given user. For example, we may select the “first weight table” of FIG. 2C for the “popular music” query, and the second table of FIG. 2C for the “gardening tips” or any other “generic” query. Thus, in this example, it is possible that user “B” is a fellow teenage girl. For the “popular music” query, user B receives a larger weight (i.e. ⅓) than for the “gardening tips” query (i.e. 1/11).

This is an example of a “query-topic dependent closeness function” the weight and/or “closeness” (i.e. for the purposes of handling the query or search retrieval function) depends on the topic of the advertisement operation and/or search query (i.e. information retrieval operation).

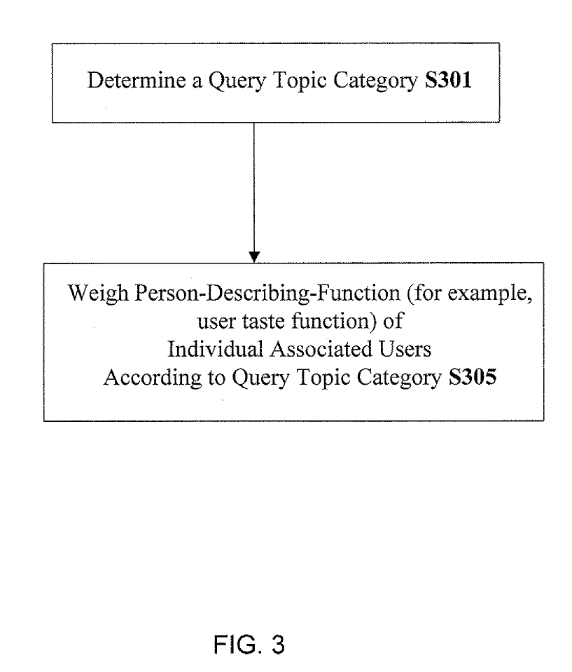

In FIG. 3, it is determined that in accordance with a “match” between a query topic category S301 and the weight function which depends on the query topic category (for the example of FIG. 2C, the two “weight functions” for user G are ⅛ and 1/11),

Thus, in FIG. 2C, the “closeness function” (or a derivative “user weight function”) is query-topic dependent—for some query topics (i.e. as determined in step S301), the ⅛ weight should be used for user G, and for other query topics the 1/11 weight should be used.

### Use of Various Electronic Media Content Features to Determine Demographic Data

Various techniques of demographically profiling users are described in US 20070186165 of the present inventors, incorporated herein by reference in its entirety.

Thus, in different embodiments, the users may be demographically profiled by analyzing (i.e. either in real-time or with some sort time delay) electronic communications. Features of electronic media content (i.e. for voice and optionally video conversations) such as the user's accent (for example, to determine a national or regional original), voice pitch (e.g. to determine a user's age), grammar and idiom usage (for example, to determine an educational level), appearance (for example, to determine a user's ethnicity or to determine a relative wealth or household income level e.g. expensive clothes may indicate more wealth).

It is noted that the “demographic profiling” may relate to step S201 and/or to step S205. For the case of S201, users having a similar demographic profile may have an elevated “level of trust” and this may provide information about the nature of their relationship. For example, when a teenage boy says “I love you” to a teenage girl, this may indicate a “boyfriend-girlfriend” relationship, while a forty year old woman saying “I love you” to a teenage girl may be indicative of a “mother-daughter” relationship.

For the case of S205, the demographic profile of the user may shed light on the users taste or preferences.

### A Discussion of Step S205

In step S205, properties and/or preferences (for example, tastes) or one or more associated users are determined.

In one example, this is determined according to clickstream.

For example, in one scenario, the associated user purchases various items (for example, books) at a given ecommerce website. These items are recorded (for example, with the user's permission) and may be indicative of the associated user's taste in books.

In another example, electronic communications of the associated user are analyzed (where permitted by law and with appropriate permissions), either with the “given user” or with a different associated user or with someone external to the “associated user network” of the given user. The associated user's “behavior” or expressed opinions in these electronic communication may be indicative of the associated user's taste, preferences, etc.

Thus, in one example relating to video conversation, if the user is seen using a particular brand of a product (for example, smoking a cigarette of a certain brand or drinking a softdrink of a given brand), this may indicate an affinity to the product and/or particular brand.

Techniques for analyzing a user's electronic communications to determine preferences and tastes are disclosed in US 20070186165 of the present inventors, incorporated herein by reference in its entirety.

### Handling a Search Query for a Given User in Accordance with the Property(ies) of the Associated User(s)

In step S209, a search query for the given user is handled in accordance with the property(ies) or tastes of one or more associated users. For example, the user may submit a request to an ecommerce site (for example, an online book vendor), and the user will be presented with a list of books determined by preferences of members of his/her social network.

Thus, in one example, if a member of the social network had purchased a given book recently (for example, on a topic related to the search query), this user may be presented to the user in a higher “position” in the list of search results, or alternatively, with an explicit message indicating that this book was purchased by a member of the social network.

In another example, a user sends a query for a cooking book. If most members of the user's social network are from a particular ethnic group (for example, Jewish), then Kosher cooking books may be presented in response to the search query.

In another example, a user seeks to vacation in a certain region, and sends a query to a travel site (for example, a site similar to Orbitz® or Traveloicty®) for travel packages. If it is determined that a large number of members of the user's social networks are students, then student travel packages may be presented. If it is determined that most the “given” user's associates are relatively wealthy, then more expensive luxury or premium travel packages may be preferred. In another example, if many of the given user's associates in the social network are immigrants from a certain region of the world, then packages to that region of the world may be presented.

### An Additional Discussion of FIGS. 2A-2C

Thus, in some embodiments, analyzed electronic communications (for example, between two associated users of the social network—for example, between users H 338 and B 314) are useful for determining one or more of: (i) a closeness function for members of the social network; and/or (ii) preferences and/or interests and/or personality and/or tastes [i.e. which can be described by a “person-describing function”].

For example, if the “associated users” B and H expresses in a phone or VOIP conversation (i.e. analyzed only as permitted by law) a liking of a certain activity (i.e. skiing), this information may be used to handling a search query for and/or providing advertising to user A. This liking may be detected by a “word feature” or “phrase feature” and/or by detecting emotions or moods or with any other “audio and/or visual” feature.

It is appreciated that this principle applies both to conversations involving “direct contacts” (i.e. users H, C and D) as well as indirect contacts.

For the present disclosure, the term “taste function” refers to a description of likes or interests by a given user.

The term “personality function” refers to a description of a given person's personality. The term “demographic” function refers to one or more demographic parameters about the user—for example, gender, age, religion, ethnicity, etc.

For the present disclosure, a “word feature” of electronic content refers to a function of words or phrases—for example, by using a speech to text converter for extracting text from audio media content.

An “audio feature” refers to sounds or noises or speech in audio media content.

An “video feature” refers to objects that appear in video media content (i.e. existence of objects or properties thereof) this may be computed using, for example, any image processing technique.

### An Additional Discussion Relating to Search Results and/or Advertisement

It is noted that by determining associated user's taste and/or interests and/or behaviors and by taking this data into account when servicing search queries and/or providing advertisement, it is possible to provide more relevant search results and/or more relevant advertisement.

As described above, there are different techniques for determining properties (e.g. taste and/or interests and/or behaviors) of associated users and/or how to “weight” each user.

Once the “person-describing function” (i.e. describing taste and/or interests and/or behaviors) of a user's social network is known, it is possible, for example, to serve advertisement content that is similar these tastes and/or interests and/or behaviors. For example, is a “friend” or “friend of friend” likes biking, it is possible to serve a given user advertisements, for example, for mountain bikes. In another example, search results are ordered accordingly—for example, vacation destinations that are popular among bikers may be ordered at a higher position in search results if the “given user” (for example, user A) has a friends with “stronger interests” and/or “closer friends” (or closer “friends of friends) and/or many friends who like biking (i.e. have the “taste” or interest in the activitiy).

### Common Interests or Taste Between the “Given User” and One or More Members of a Social Network

### Either Direct and/or Indirect Contacts

In another variation, it is possible to detect the tastes and/or interests and/or behaviors of the given user A 310 him/herself (i.e. the user to be served electronic advertisement and/or for whom a search query needs to be serviced)—this may be carried out in any manner such as by analyzing electronic communications of the “given” user or a mySpace® profile or in any other manner. Also, we locate users in the social network with “closely” matching interests and/or tastes and/or behavior (by detecting, for example, the tastes and/or interests and/or behavior of a given “associated user” or “friend” in the social network—for example, as described with reference to step S205).

In the event that we find a “close match” (or the “closest available” match), several options are possible. In one variation, if for example, user “A” 310 (the “given user”) and user “B” 314 (the “associated user”) are both interested in “biking,” it is possible to examine additional user tastes and/or interests and/or preferences of the “friend” or “associated user.” In accordance with these additional user tastes, it is possible to provide information retrieval services to the “given user.”

In one non-limiting example, both the “given user” and the “associated users” like, for example Latin American culture, If the “associated user” also likes boating, an advertisement for boating may be served to the “given user.” If the “associated user” is particularly “close” to the “given user” this may be given a “stronger weight.”

In another variation, a “given user” is provided with search and/or electronic advertisement services according to the “given user's interests.” Nevertheless, this may be weighed according to the interests or his or her social network. Thus, the given user may list, say, interests in a Facebook® profile (or as determined in any other manner): skiing, cooking, camping, ballroom dancing, and dogs. In this example, it is not known which of these interests (or known only with a limited certainty) is most “important” In this example, by investigating the interests of the given user's “friends” in the social network and seeking out “common interests” (i.e. those expressed by the given user's friends—as expressed by an “interest commonality function”), it is possible to estimate which of the 5 interests is most important to the “given user” and to provide interest retrieval functions accordingly.

### An Additional Discussion About “Search Queries”

It is noted that the “search query” may refer to a “generic information-seeking query” (like a Google® query) and/or to an e-commerce search query (for example, a query for a product) or any other search query. It may refer to searching one or more publicly available information repositories and/or non-publicly available via the Internet or an intranet or in any other computer network.

### Descriptions of Exemplary Systems for Handling Information Retrieval in Accordance with Associated Users of a Social Network

In some embodiments, the system may also include a web interface: any person (including people who are not registered users) can access the web page, perform a search and receive the top results that the system users have contributed for a given context. In addition, registered users may see a textual or graphical rendering of the user's network of contacts, allowing him to discover new contacts (through N^{th} degrees of separation) as well as indicate which users are trusted, indicate personal domains of expertise, etc.

The system collection and presentation is not restricted to the web or to search engines for that matter; the system can be incorporated within an Instant Messenger client, VoIP client, mobile phone, TV, etc.

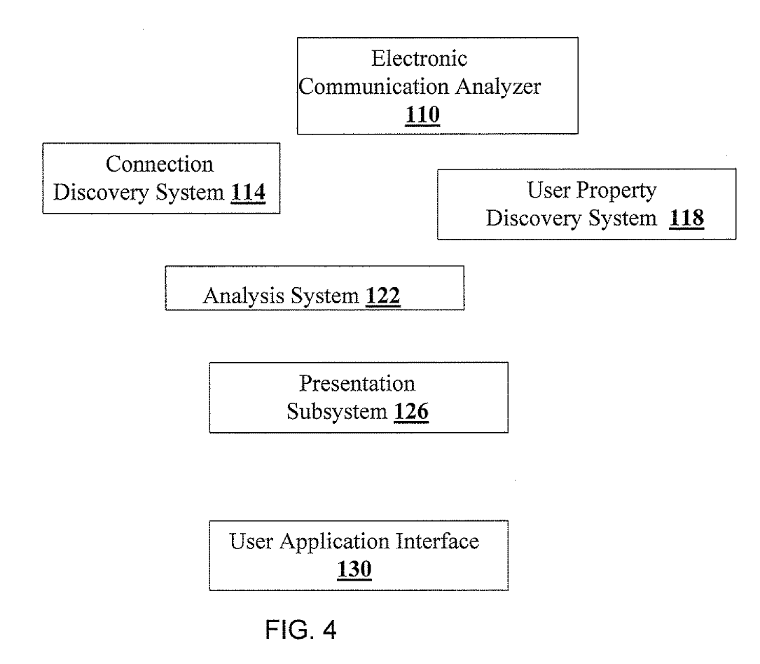

FIG. 4 provides a block diagram of an exemplary system for handling information retrieval according to a given user's social network.

Connection discovery subsystem 114 identifies people who are related to the user or to the context. In some embodiments, connection discovery system 114 identifies the one or more of the following group types in the network: (i) The user himself (ii) The user's friends, and (iii) friends-of-friends, etc (i.e. indirect contact). Friends and contacts can be discovered through one or more of Instant Messenger contact list, email, social networks, etc. People who have a similar demographic background Users who are domain experts—people who frequently search for information on a specific context.

In some embodiments, the existence of a “contact relationship” and/or the closeness or type of relationship may be determined by connection discovery system 114 in accordance with analyzed electronic communications between users as obtained by electronic communication analyzer 110.

In the present example, connection discovery system 114 also handles use registration and profile management.

Another component in FIG. 4 is “User Property Discovery System 118.” This may be operative to discovering, for a given “associated user,” the behavior and/or intentions and/or tastes and/or activities of the associated user. In one example, User Property Discovery System tracks and records the clickstream of each associated user. Each user's clickstream is associated with the context (e.g., a search query, advertisement), then staged and gets stored in a repository.

Another component in FIG. 4 is Analysis subsystem 122. In one non-limiting example, the analysis subsystem 122 ranks the information using an algorithm that weighs the relative contribution of each user's clickstream depending on his relatedness and trust level. For example, the clickstream of a user's direct friend may be given more weight than a user who merely shares the same demography.

The system of FIG. 4 also includes a presentation subsystem 126. When a context is provided, the presentation system engages the analysis subsystem and presents the information on the presentation device.

User Application Interface 130 acts as a front-end to the context repository and the social network. The interface enables users to search for highly relevant information and view/manage their social network.

It is noted that the examples are intended as illustrative and not limiting. Furthermore, any component disclosed in FIG. 4 may be implemented in any combination of hardware and/or software, may be localized to a single machine or distributed among multiple machines deployed in a computer or communications network.

In the description and claims of the present application, each of the verbs, “comprise” “include” and “have”, and conjugates thereof are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of providing information retrieval services, the method comprising:
a) for a plurality of users, analyzing content of multi-party electronic communications between individual users of said plurality of users, said analyzed electronic communications including at least one of text chat communications and voice-content-including media communications;
b) for a given user of said plurality of users, determining S201, a social network comprising a plurality of distinct indirect contacts;
c) for each indirect contact of said plurality of indirect contacts of said social network, determining a respective indirect contact social network closeness function S201 between said given user and said each indirect contact from at least one of:
i) at least one word feature of said analyzed content of said electronic communications;
ii) at least one audio feature of said analyzed content of said electronic communications, and
iii) at least one video feature of said analyzed content of said electronic communications;
d) effecting S209 at least one information retrieval operation selected from the group consisting of:
i) handling a search query; and
ii) providing advertising,
in accordance with said determined indirect contact social network closeness functions.

2) The method of claim 1 wherein said indirect contact social network closeness functions are determined in accordance with said word features of said analyzed content.

3) The method of claim 1 wherein said indirect contact social network closeness functions are determined in accordance with said audio features of said analyzed content.

4) The method of claim 1 wherein said indirect contact social network closeness functions are determined in accordance with said video features of said analyzed content.

5) The method of claim 1 wherein said indirect contact social network closeness functions are determined in accordance an audio speech delivery feature of said analyzed content selected from the group consisting of:
a) a voice pitch feature;
b) a voice inflection feature;
c) a voice loudness feature; and
d) a speech tempo feature.

6) The method of claim 1 wherein said indirect contact social network closeness functions are determined in accordance with at least one of:
i) at least one emotion feature of said analyzed content;
ii) at least one mood feature of said analyzed content.

7) The method of claim 1 wherein the method further includes:
e) determining S205 for said each indirect contact of said plurality of indirect contacts, a respective at least one user person-describing function selected from the function group consisting of:
i) a respective taste function;
ii) a respective personality function;
iii) a respective demographic function;
wherein said handling of said at least one information retrieval operation is carried out in accordance with said person-describing functions weighted according to said closeness functions.

8) The method of claim 7 wherein at least one said respective person-describing function for said each indirect contact is determined at least in part by a clickstream of a respective device of said each indirect contact.

9) The method of claim 7 wherein said respective at least one respective person-describing function for said each indirect contact is determined at least in part by at least one of:
i) said at least one word feature of said analyzed content of said electronic communications;
ii) said at least one audio feature of said analyzed content of said electronic communications, and
iii) said at least one video feature of said analyzed content of said electronic communications.

10) The method of claim 7 where said respective demographic function for said each indirect contact is determined at least in part by at least one of:

11) The method of claim 7 wherein said at least one feature includes at least one demographic feature selected from the group consisting of:
i) a gender feature;
ii) an educational level feature;
iii) a household income feature;
iv) a weight feature;
v) an age feature; and
vi) an ethnicity feature.

12) The method of claim 10 wherein at least one said demographic feature is determined in accordance with at least one:
i) an idiom feature of said analyzed content of said electronic communications;
ii) an accent feature of said analyzed content of said electronic communications;
iii) a grammar compliance feature of said analyzed content of said electronic communications;
iv) a voice characteristic feature of said analyzed content of said electronic communications;
v) a sentence length feature of said analyzed content of said electronic communications; and
vi) a vocabulary richness feature of said analyzed content of said electronic communications.

13) The method of claim 1 wherein said determined closeness function is a query-topic independent closeness function.

14) The method of claim 1 wherein said determined closeness function is a query-topic dependent closeness function.

15) The method of claim 1 wherein said handling of said search query includes providing, in accordance with said determined indirect contact social network closeness functions, an order for search results.

16) The method of claim 1 wherein said handling of said search query includes associating, with a list of search results, in accordance with said determined indirect contact social network closeness functions, a description of at least one preference of at least one said indirect contact.

17) A method of providing information retrieval services, the method comprising:
a) for a plurality of users, analyzing content of multi-party electronic communications between individual users of said plurality of users, said analyzed electronic communications including at least one of text chat communications and voice-content-including media communications;
b) for a given user of said plurality of users, determining S201, a social network comprising a plurality of distinct indirect contacts;
c) for each indirect contact of said plurality of indirect contacts of said social network, determining S205 a respective at least one user person-describing function selected from the function group consisting of:
i) a respective taste function;
ii) a respective personality function;
iii) a respective demographic function,
in accordance with at least one of:
i) at least one word feature of said analyzed content of said electronic communications;
ii) at least one audio feature of said analyzed content of said electronic communications, and
iii) at least one video feature of said analyzed content of said electronic communications,
d) effecting at least one information retrieval operation selected from the group consisting of:
i) handling a search query; and
ii) providing advertising,
in accordance with at least one said user person-describing function.

18) A method of providing information retrieval services, the method comprising:
a) determining, for a given user, a social network including a plurality of associated users;
b) analyzing electronic media content of multi-party electronic communications between at least two said associated users, said analyzed electronic communications including at least one of text chat communications and voice-content-including media communications;
c) in accordance with at least one of:
i) at least one word feature of said analyzed content of said electronic communications;
ii) at least one audio feature of said analyzed content of said electronic communications, and
iii) at least one video feature of said analyzed content of said electronic communications,
effecting at least one information retrieval operation selected from the group consisting of:
i) handling a search query for said given user; and
ii) providing advertising for said given user.

19) The method of claim 18 wherein said at least two associated users include at least two indirect contacts of said social network.

20) A method of providing information retrieval services, the method comprising:
a) determining, for a given user, a social network including a plurality of associated indirect contacts;
b) for each said associated indirect contact of a plurality of said plurality of contacts, determining a respective user interest commonality function of:
(i) said given user;
(ii) said each associated contact; and
c) in accordance with said determined interest commonality functions, effecting at least one information retrieval operation for said given user selected from the group consisting of;
i) handling a search query; and
ii) providing advertising.

21) The method of claim 20 wherein:
i) said determining of said social network includes determining respective closeness functions of said each associated indirect contact;
ii) said interest commonality function-dependent effecting of said at least one information retrieval operation is carried out in accordance with said determined closeness functions.

22) An apparatus for providing information retrieval services, the apparatus comprising:
a) an electronic communication analyzer 110 operative, for a plurality of users, to analyze content of multi-party electronic communications between individual users of said plurality of users, said analyzed electronic communications including at least one of text chat communications and voice-content-including media communications;
b) a connection discovery system 114, operative, for a given user of said plurality of users, to determining a social network comprising a plurality of distinct indirect contacts;
c) an analysis system 122 operative, for each indirect contact of said plurality of indirect contacts of said social network, to determine a respective indirect contact social network closeness function between said given user and said each indirect contact from at least one of:
i) at least one word feature of said analyzed content of said electronic communications;
ii) at least one audio feature of said analyzed content of said electronic communications, and
iii) at least one video feature of said analyzed content of said electronic communications;
d) an information retrieval system operative to effect at least one information retrieval operation selected from the group consisting of:
i) handling a search query; and
ii) providing advertising,
in accordance with said determined indirect contact social network closeness functions.

23) An apparatus for providing information retrieval services, the apparatus comprising:
a) an electronic communication analyzer 110 for a plurality of users, to analyze content of multi-party electronic communications between individual users of said plurality of users, said analyzed electronic communications including at least one of text chat communications and voice-content-including media communications;
b) a connection discovery system 114, operative, for a given user of said plurality of users, to determining a social network comprising a plurality of distinct indirect contacts;
c) an analysis system 122 operative, for each indirect contact of said plurality of indirect contacts of said social network, to determine a respective at least one user person-describing function selected from the function group consisting of:
i) a respective taste function;
ii) a respective personality function;
iii) a respective demographic function,
in accordance with at least one of:
i) at least one word feature of said analyzed content of said electronic communications;
ii) at least one audio feature of said analyzed content of said electronic communications, and
iii) at least one video feature of said analyzed content of said electronic communications,
d) an information retrieval system operative to effect at least one information retrieval operation selected from the group consisting of:
i) handling a search query; and
ii) providing advertising,
in accordance with at least one said user person-describing function.

24) A apparatus of providing information retrieval services, the apparatus comprising:
a) a connection discovery system 114 operative to determine, for a given user, a social network including a plurality of associated users;
b) an electronic communication analyzer 110 operative to analyze electronic media content of multi-party electronic communications between at least two said associated users, said analyzed electronic communications including at least one of text chat communications and voice-content-including media communications;
c) an information retrieval system operative in accordance with at least one of:
i) at least one word feature of said analyzed content of said electronic communications;
ii) at least one audio feature of said analyzed content of said electronic communications, and
iii) at least one video feature of said analyzed content of said electronic communications,
to effect at least one information retrieval operation selected from the group consisting of:
i) handling a search query for said given user; and
ii) providing advertising for said given user.

25) An apparatus for providing information retrieval services, the apparatus comprising:
a) a connection discovery system 114 operative to determine, for a given user, a social network including a plurality of associated indirect contacts;
b) an analysis system 122 operative for each said associated indirect contact of a plurality of said plurality of contacts, to determine a respective user interest commonality function of;
(i) said given user;
(ii) said each associated contact; and
c) an information retrieval system operative in accordance with said determined interest commonality functions, to effect at least one information retrieval operation for said given user selected from the group consisting of;
i) handling a search query; and
ii) providing advertising.
